(19) United States
(12) Patent Application Publication
(10) Pub. No.: US 2011/0268926 A1
(43) Pub. Date: Nov. 3, 2011

(54) INTERNAL STRUCTURE FOR AIRCRAFT IN COMPOSITE MATERIAL

(75) Inventors: Francisco Jose CRUZ DOMINGUEZ, Getafe (ES); Elena AREVALO RODRIGUEZ, Getafe (ES)

(73) Assignee: AIRBUS Operations S.L., Madrid (ES)

(21) Appl. No.: 13/028,602

(22) Filed: Feb. 16, 2011

(30) Foreign Application Priority Data
Apr. 30, 2010 (ES) ES 201030647

(51) Int. Cl. B64C 1/06; B32B 3/00

(52) U.S. Cl. 428/172

(57) ABSTRACT

Internal structure for aircraft comprising a skin (1) of composite material, some stringers (2) of composite material integrated into the interior of the aforementioned skin (1) and some frames (3) of composite material, comprising the skin (1) with some zones (4) in which its thickness (20) is greater than the thickness (10) this skin (1) has in the rest of its section, with the stringers (2) integrated into these zones (4) of the skin (1), achieving with this arrangement the isolation of the interface line (5) of the stringer (2) joint with the skin (1) from the skin (1) with thickness (10).

### FIELD OF THE INVENTION

This invention refers to an internal structure for an aircraft made from composite material, in particular for fuselages for aeronautical structures.

### BACKGROUND OF THE INVENTION

It is widely known that aeronautical structures are designed seeking to optimize them to minimize weight while meeting the criteria for strength and stiffness. One consequence of this requirement is the ever more extensive use of composite materials in primary structures as, by appropriately applying the aforementioned composite materials, significant savings in weight can be made in comparison to a design with a metallic material and a series of other advantages obtained.

It is known as an integrated structure when the different elements of which it is made up are manufactured at the same time in a single process: this is the other advantage of the use of composite materials. This feature leads to cost savings for structures made from composite materials as it greatly reduces the number of individual parts it is necessary to assemble, this being an essential requirement when competing in the market.

The aircraft's internal structures which form its fuselage comprise skin panels, stringers and frames. The skin is stiffened longitudinally by means of the stringers, at the same time as weight optimization is sought for the aforementioned skin. The frames prevent general instability in the fuselage, also helping with the optimization of the skin, at the same time as serving to transmit local load inputs to the combined structure.

The known aircraft fuselage skins made in composite material integrate the stringers into the aforementioned skin by means of a co-bonding or co-curing procedure. In these known skins, the frames are riveted to the skin.

The skin can be manufactured in a single piece to cover the 360° (known as a one-shot fuselage), with this fuselage being conical or cylindrical, or can be manufactured separately in several panels to be mechanically joined subsequently (known as a panel or panelized solution). In both cases, the stringers can be both co-bonded and co-cured to the internal surface of the skin such that an integrated combination is finally obtained, made up of the skin and the stringers, which do not have riveted joints. The frames, however, are connected to the aforementioned combination by means of riveting to the skin.

In order to achieve greater optimization of the skin in terms of weight, current designs seek “post-buckling” conditions before reaching ultimate load, with post-buckling being understood as the recoverable phase of the structure between buckling and collapse or breakage. In this way, the current designs allow local buckling of the skin between the stringers before reaching ultimate load. This post-buckling capacity is limited to certain load levels, below which buckling is not permitted, in order to prevent problems of detachment of the stringers, which are co-bonded or co-cured to the skin. This limits the weight optimization of the structure.

It would, therefore, be desirable to provide a skin structure with integrated stringers, increasing the postbuckling capabilities, such that this structure has greater weight optimization than the known structures.

This invention is aimed at providing a solution in this regard.

### SUMMARY OF THE INVENTION

This invention refers to an internal structure for an aircraft made in composite material, in particular in fuselages for aeronautical structures, which comprises a composite material skin, some stringers integrated by co-bonding or co-curing to the inside of the aforementioned skin and some frames which are either riveted or integrated by co-bonding or co-curing to the inside of the aforementioned skin. The skin in turn comprises zones of increased thickness in the form of strips or integrated lay-up track, in which the thickness of the skin is greater than its thickness in the rest of the section. The stringers are integrated onto these zones of greater thickness by means of a co-bonding or co-curing process. This achieves the isolation of the interface line of the joint between the stringer and the skin from the zone of the skin in which the buckling takes place.

The above internal structure for the aircraft achieves a design in which the post-buckling capacity is increased, so permitting buckling in the zone of the skin located between stringers which is greater than that permitted by means of a skin which does not comprise zones of greater thickness, without leading to detachment of the stringers from the skin onto which they are arranged, thanks to the interface line of the joint of these stringers being separated or isolated from the zone of the skin which undergoes buckling.

The zones of the skin in which its thickness is higher than the thickness this skin has in the rest of its section can be located in the zone of the joint between the stringers and the skin, in the zone of the joint between the frames and the aforementioned skin or outside of the stringer-skin and frame-skin joint zones, in an isolated form in the skin itself, as will be detailed below.

The invention's aforementioned solutions are valid both in the case that the frames are riveted to the skin and that they are integrated (co-bonded or co-cured) into it.

The main advantages achieved by this invention are as follows: the design of the internal structure is more highly integrated, with greater weight optimization, and provides a structure which is more tolerant to damage, at the same time that the structure saves costs by combining large sheets of base skin to obtain the structure's final configuration.

Other characteristics and advantages of this invention will emerge from the detailed description which follows from an illustrative embodiment of its subject in relation to the accompanying figures.

### DESCRIPTION OF THE FIGURES

FIGS. 1a, 1b and 1c show, in diagram form, the elements which make up the internal structure of the fuselage of an aircraft made from composite materials, according to a first embodiment of this invention.

FIGS. 2a, 2b and 2c show, in diagram form, the elements which make up the internal structure of the fuselage of an aircraft made from composite materials, according to a second embodiment of this invention.

FIGS. 3a, 3b and 3c show, in diagram form, the arrangement of the zones of the skin with greater thickness in their crossing zones, in the core of the internal structure of the fuselage of an aircraft made from composite material, according to this invention.

FIGS. 4a to 4f show, in diagram form, the arrangement of the skin zones of greater thickness in the internal structure of an aircraft made from composite material, according to several embodiments of this invention.

FIGS. 5a, 5b and 5c show, in diagram form, the arrangement of the skin zones of greater thickness in the core of the internal structure of an aircraft made from composite material, according to a variant of this invention.

FIGS. 6a, 6b and 6c show, in diagram form, the arrangement of the skin zones of greater thickness in the core of the internal structure of an aircraft made from composite material, according to another variant of this invention.

### DETAILED DESCRIPTION OF THE INVENTION

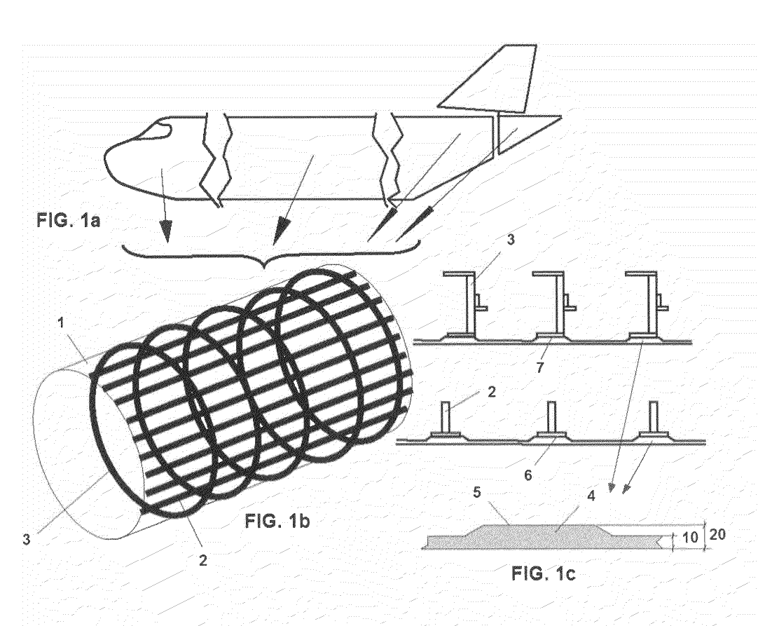

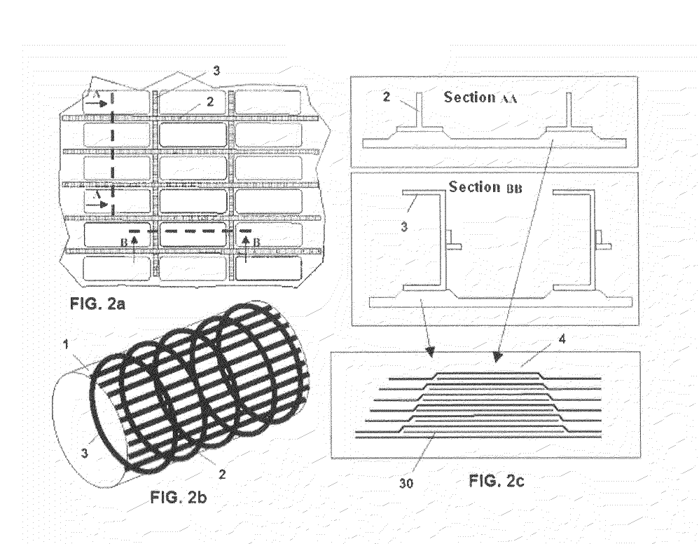

This invention refers to the internal structure of the fuselage of an aircraft made from composite material. This structure comprises a skin 1 of composite material, some stringers 2 integrated by means of co-bonding or co-curing into the skin 1 and some frames 3. The frames 3 can be riveted or integrated by means of co-bonding or co-curing to the skin 1 of the structure. The skin 1 comprises some zones 4 in which the thickness 20 of the skin 1 is greater than the thickness 10 which this skin 1 has in the rest of its section (see FIGS. 1c and 2c). According to a preferred embodiment, the stringers 2 are integrated into the skin 1 in these zones 4 by means of a co-bonding or co-curing process. With this arrangement the interface line 5 of the joint between the stringers 2 and the skin 1 is as far as possible from the zone of the skin 1 with lower thickness 10, which is the zone of this skin 1 which undergoes buckling.

The above structure permits the buckling of the skin 1 located between the stringers 2, without the stringers 2 becoming detached from the skin 1, which is greater than that obtained by means of a skin 1 which does not comprise the zones 4 of greater thickness.

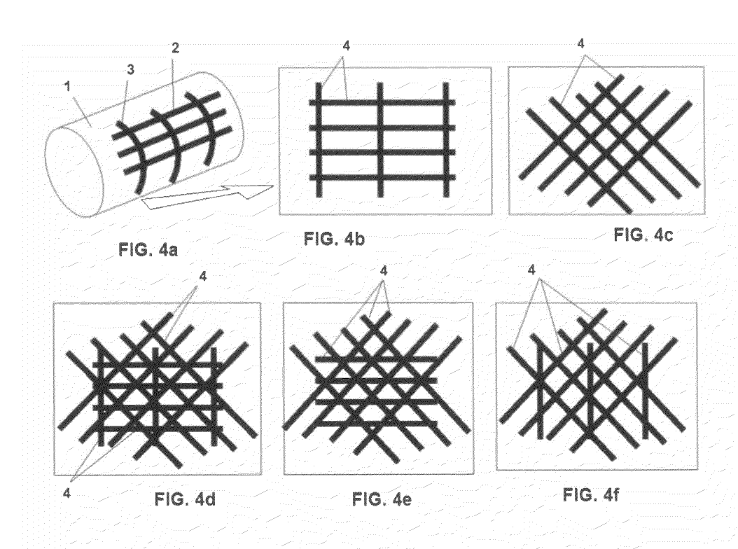

The abovementioned zones 4 can be located in the zone 6 of the joint between the stringers 2 and the skin 1 and in the zone 7 of the joint between the frames 3 and the skin 1, locating these zones 4 parallel to the direction of the structural component which they support, the stringer 2 or the frame 3, as shown in FIG. 2c. In addition, these zones 4 can also be located outside of the stringer 2—skin 1 and frame 3—skin 1 junction zones, being arranged in an isolated form in the skin 1 itself. As such, there are various possibilities: in addition to the existence of zones 4 of reinforcement in the direction of the stringers 2 and in the direction of the frames 3 (FIG. 4b), these zones 4 of reinforcement can be located on diagonals (FIG. 4c); on a diagonal, over the stringers 2 and frames 3 (FIG. 4d); on a diagonal and over the stringers 2 (FIG. 4e); on a diagonal and over the frames 3 (FIG. 4f); and others.

The skin 1 of the structure of the invention is applicable both to fuselages in a single piece over 360 degrees and to fuselages manufactured in several panels of the aforementioned skin 1. The composite material which makes up the structure can be carbon fibre or glass fibre with thermosetting or thermoplastic resin.

Although the main field of application of the structure of the invention is for fuselages for aeronautical structures, it can also be applied to other structures with similar characteristics, such as aircraft torsion boxes, for example.

The invention manages to optimize the design of the composite material skin 1 by increasing its post-buckling capacity by means of zones 4 of greater thickness, which are achieved by means of integrating layers of composite material of the same material as that of the skin 1 into the core of the skin 1 itself, so obtaining an integrated laminate (FIG. 2c). Another possibility for achieving increased thickness in the zones 4 of the skin 1, apart from layer by layer as indicated (integrated laminate), is by means of the use of patches 30 of carbon fibre integrated into the skin 1 itself. In both cases, these zones 4 isolate the interface line 5 between the stringer 2 and the skin 1 as far as possible.

The invention described herein is applicable both to preimpregnated materials and dry fibre materials, it being possible to use resin infusion techniques for manufacturing in the latter case.

As such, the invention structure has all the advantages of an integrated structure, plus weight optimization and greater capacity for damage tolerance, on comprising contention zones provided by the zones 4 of greater thickness. The invention can be applied to any stringer 2 type or shape and to any frame 3 type or shape.

In this way, the final configuration of the skin 1 per the invention is basically a series of hoops made up of zones 4 integrated into the skin 1.

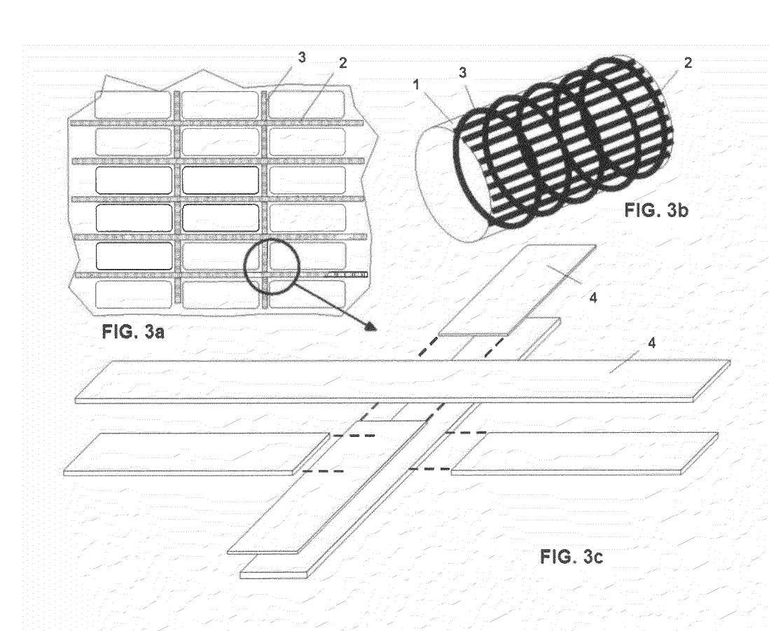

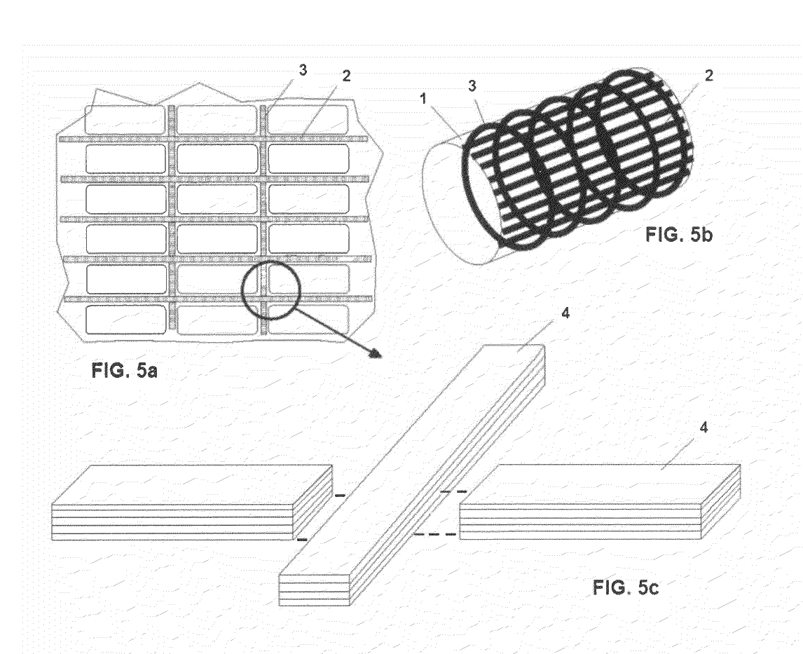

Typically, as shown in FIGS. 3a to 3c, the crossings between the zones 4 of greater thickness of the skin 1 in the core of the aircraft structure is achieved by cutting the layers of reinforcement alternately in the zones 4 of greater thickness. This solution for the crossings of increased thickness is not unique, it being possible to define other solutions for the crossings in which the number of fabrics cut predominate more in one direction than the other, with it being possible to reach the extreme in which all the fabrics which make up the increased thickness in one direction are cut when they reach the crossing (FIGS. 5a, 5b and 5c).

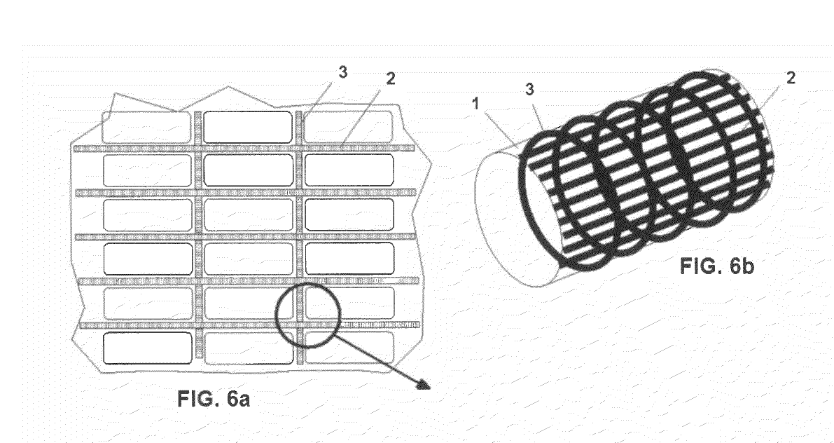

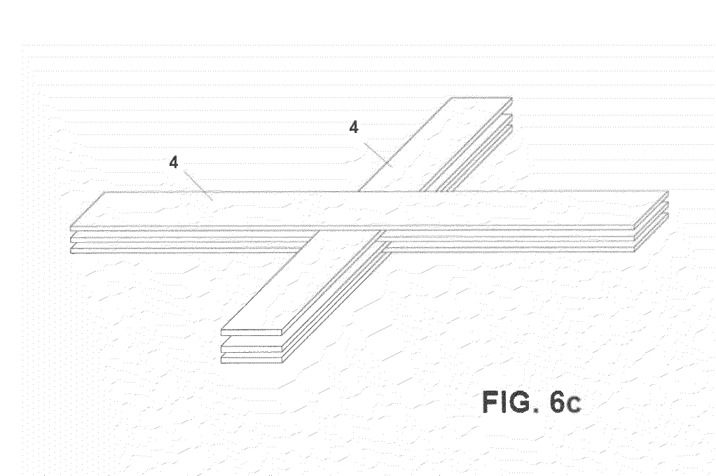

Another of the options for making the crossing of the fabrics mentioned above is shown in FIGS. 6a, 6b and 6c, in which it can be seen that all the fabrics which make up the increased thickness continue without being cut.

Those modifications comprised within the scope defined by the following claims may be introduced to the embodiments described above.

1. An internal structure for aircraft comprising a skin (1) of composite material, some stringers (2) of composite material integrated into the interior of the aforementioned skin (1) and some frames (3) of composite material, characterized in that the skin (1) comprises some zones (4) in which its thickness (20) is greater than the thickness (10) this skin (1) has in the rest of its section, with the stringers (2) integrated into these zones (4) of the skin (1), achieving with this arrangement the isolation of the interface line (5) of the stringer (2) joint with the skin (1) from the skin (1) with thickness (10);

2. An internal structure for aircraft according to claim 1, in which the zones (4) of the skin (1) of greater thickness are arranged in the zone of the skin (1) onto which the stringers (2) are located, with these zones (4) furthermore being arranged parallel to the direction of the aforementioned stringers (2);

3. An internal structure for aircraft according to claim 1, in which the zones (4) of the skin (1) of greater thickness are arranged in the zone of the skin (1) onto which the frames (3) are located, with these zones (4) furthermore being arranged parallel to the direction of the aforementioned frames (3);

4. An internal structure for aircraft according to any of the previous claims, in which the zones (4) of greater thickness are obtained by means of the integration of composite material of the same material as the skin (1), into the core of the skin (1) itself, obtaining an integrated laminate;

5. An internal structure for aircraft according to any of the claims 1-3, in which the zones (4) of greater thickness are obtained by means of the use of patches (30) of composite material of the same material as the skin (1), with these patches (30) being integrated into the skin (1) itself;

6. An internal structure for aircraft according to any of the previous claims, in which the crossing between the zones (4) of greater thickness of the skin (1) in the core of the aircraft structure is achieved by cutting the layers of reinforcement alternately in the zones (4) of greater thickness;

7. An internal structure for aircraft according to any of the claims 1-5, in which the zones (4) of greater thickness of the skin (1) predominate more in one direction than the other;

8. An internal structure for aircraft according to any of the previous claims, in which the stringers (2) are co-bonded or co-cured onto the interior of the skin (1);

9. An internal structure for aircraft according to any of the previous claims, in which the frames (3) are co-bonded or co-cured or riveted onto the interior of the skin (1);

10. An internal structure for aircraft according to any of the previous claims, in which the composite material of the skin (1), the stringers (2) and the frames (3) is carbon fibre with thermosetting or thermoplastic resin;

11. An internal structure for aircraft according to any of the claims 1-9, in which the composite material of the skin (1), the stringers (2) and the frames (3) is glass fibre with thermosetting or thermoplastic resin.
